(19) United States
(12) Patent Application Publication
(10) Pub. No.: US 2015/0086944 A1
(43) Pub. Date: Mar. 26, 2015

(54) DRIVING TRAINING DEVICE

(71) Applicant: Wolfgang MICHELITSCH, Klagenfurt (AT)

(72) Inventors: Wolfgang MICHELITSCH, Klagenfurt (AT); Wolfgang FERLITZ, Bruchsal (DE)

(21) Appl. No.: 14/036,643

(22) Filed: Sep. 25, 2013

(51) Int. Cl. G09B 9/042

(52) U.S. Cl. CPC G09B 9/042
USPC 434/68

(57) ABSTRACT

The invention relates to an obstacle for a driving training device comprising a unit which can be moved, essentially in a straight line, between a resting position and a working position. Accordingly, it is provided that the unit includes a flexible sleeve and a reset device for returning the sleeve to the resting position. Furthermore, the invention relates to a method for extending a spontaneously appearing and solid-looking object on a roadway using a driving training device that includes at least one obstacle with a unit that has a flexible sleeve and that is moved, essentially in a straight line, between a resting position and a working position. Accordingly, it is provided that the unit with the flexible sleeve is automatically moved to the working position and, if necessary, automatically returned to the resting position during an approach of a training vehicle to the driving training device.

### CROSS-REFERENCE TO RELATED APPLICATIONS

The present application is related to Austrian Patent Application No. 50030/2012, filed Feb. 10, 2012, the disclosure of which is expressly incorporated by reference herein in its entirety.

### BACKGROUND OF THE INVENTION

1. Field of the Invention

The invention relates to an obstacle for a driving training device comprising a unit which can be moved, essentially in a straight line, between a resting position and a working position.

Furthermore, the invention relates to a method for extending a spontaneously appearing and solid-looking object on a roadway using a driving training device which comprises at least one obstacle with a unit that has a flexible sleeve and that is moved, essentially in a straight line, between a resting position and a working position.

2. Discussion of Background Information

Various driving training devices that have obstacles have become known from the prior art. Thus, a device is for example known in which obstacles are portrayed by fountains of water suddenly appearing in front of a driver. These devices have the disadvantage that the fountains of water only convey an inadequate impression of an obstacle and that the driver is not sufficiently prepared for solid obstacles in road traffic.

Moreover, solid lifting bodies or movable bollards have become known as obstacles which are used to cordon off streets, preferably in congested urban areas. However, devices of this type are not suitable as driving training devices, since vehicles would be damaged on contact with the lifting bodies. Furthermore, the speeds that are achievable during an extension of lifting bodies of this type are mostly not suitable for an application purpose of this type.

### SUMMARY OF THE INVENTION

The object of the invention is to disclose an obstacle of the type named at the outset, with which the disadvantages of devices from the prior art are avoided or at least reduced. In particular, the speeds required for driving training devices are to be achievable with an obstacle according to the invention, and a collision with a vehicle is to result in no damage to the vehicle.

Furthermore, a method of the type named at the outset is to be disclosed which is suitable for driving training and which at least reduces the disadvantages of methods from the prior art.

The first object is attained according to the invention in that, for an obstacle of the type named at the outset, the unit comprises a flexible sleeve and a reset device for returning the sleeve to the resting position.

Because the unit has a flexible sleeve, no damage occurs to the vehicle in a collision of the vehicle with the obstacle. Moreover, the obstacle with the flexible sleeve can be moved considerably more quickly than a rigid obstacle. Furthermore, with the reset device it is possible to quickly bring the obstacle back to the resting position, so that collisions can mostly be avoided. For example, compared to obstacles that are only moved to the resting position by a weight, significantly higher speeds can be achieved during a movement from the working position to the resting position. The obstacle can thus remain in the working position longer and convey an impression that is closer to reality than in the case of devices from the prior art.

Preferably, it can be provided that the unit can be actuated pneumatically. The flexible or elastic sleeve can thus for example also be inflated in the working position, whereby the impression of a solid body is reinforced. An obstacle that is essentially composed of an elastic body can thus also be realized in a particularly simple manner, so that a risk of causing damage to the vehicle is further reduced. In the case of an embodiment of this type, a collision of the vehicle with the obstacle also does not result in any significant damage to the obstacle itself. However, alternative drive types, such as movement by means of a rack, a linear motor, or a rope with which the obstacle is raised, are of course also equally possible.

Preferably, a guide is provided which comprises a sliding cylinder and a sliding part. The unit, which is preferably arranged on the guide movably in a vertical direction, can thus be moved along a predefined path between the resting position and the working position. The sliding cylinder can thereby be embodied as a commercially available tube in order to minimize the costs. If the sliding cylinder is embodied in such a manner, the movement from the resting position to the working position preferably runs along a tube axis, while no relative motion is possible in any of the other directions. The sliding cylinder is thereby preferably permanently anchored beneath the roadway and the unit is extended along the sliding cylinder during operation, so that only the flexible sleeve protrudes above the roadway. The sliding part is thereby connected to the unit and enables a particularly well-guided movement between the resting position and the working position. A rotation of the sliding cylinder about its axis is of course also possible.

It is advantageous that the guide is embodied with stops for the unit at a head end and at a base end. The resting position and the working position can thus be particularly simply defined in that the unit, which is connected to the sliding part, bears via the sliding part against an upper stop in the working position and against a lower stop in the resting position. Furthermore, high accelerating forces can hereby also be absorbed so that high speeds of the obstacle can be realized.

It has proven effective that the sleeve is movably arranged on the sliding cylinder via the sliding part. Because the unit is guided better during the movement between the resting position and the working position, and because flapping motions are essentially avoided, the impression of a rigid body arises. An improved impression of a solid body is hereby conveyed to the driver.

Expediently, it is provided that the reset device is connected to the sliding cylinder and the unit. Because the sliding cylinder is preferably arranged in a fixed manner relative to the roadway during operation, a reset force which is dependent on a displacement of the unit out of the resting position can be achieved particularly easily using an arrangement of this type. A quick retraction of the obstacle can thus be ensured.

The reset device is preferably embodied as a spring. Although other reset devices such as linear motors or magnetic devices are also possible, functioning is ensured even during the loss of power in the case of a spring. The spring can be arranged between the stops mentioned.

Preferably, it can also be provided that the reset device is embodied as a pneumatic actuator, in particular as a pneumatic cylinder. Actuators of this type have the advantage of a low maintenance intensity and can achieve high speeds. It is particularly advantageous to apply a pneumatic actuator, even though the obstacle is actuated pneumatically, since necessary compressed air can then be used to move the obstacle both from the resting position to the working position and also from the working position to the resting position.

It can also be provided that the sleeve has a braiding, in particular a braided hose. A braiding is on the one hand sturdy and resilient, so that a collision with a vehicle does not result in any significant damage to the vehicle or the sleeve. On the other hand, commercially available hoses can thus be used as a part of the obstacle in a particularly simple manner. Because hoses of this type are also available in an air-tight design, such a hose can be used particularly advantageously in a pneumatically actuated obstacle.

Preferably, it is also possible that at least one sealing element attached to the sliding cylinder or sliding part is provided. Particularly during an actuation of the obstacle that is based on pneumatics or hydraulics, a leak occurring between the sliding cylinder and sliding part can thus be avoided or at least minimized.

It is advantageous that the sliding cylinder is arranged in a stationary manner and embodied hollowly, wherein the unit with the sleeve is arranged on the sliding cylinder movably in a direction so that compressed air can be fed into the sleeve through the hollow sliding cylinder. Preferably, the unit thereby has a braided hose as a sleeve, which braided hose is closed on a top side and is on a bottom side connected to a sliding ring that is guided on the sliding cylinder. It can also be provided that the unit is only formed by the reset device and the braided hose closed on one side, which braided hose is permanently connected to the sliding part and the reset device. Preferably, the unit is connected to the sliding cylinder via a spring as a reset device. For the extension of the object, compressed air, preferably at 1 to 2 bar excess pressure, is guided through an inlet valve and the hollow sliding cylinder, which is preferably embodied as a metal tube. The unit with the sleeve is hereby moved along the sliding cylinder from the resting position to the working position, where the unit bears against the upper stop. In order to move the unit back to the resting position again, an outlet valve is opened through which the compressed air can escape. The inlet and outlet valves are preferably embodied in a magnet-actuated manner. The reset force of the spring subsequently causes a quick return movement of the unit to the resting position, where the unit bears against the lower stop. Alternatively, the unit can also be embodied as an expansion bellows so that no guiding device is necessary and so that, during a movement from the resting position to the working position, the unit increases a volume in which compressed air can be stored.

Preferably, it is provided that a length of the sleeve does not exceed a length of the sliding cylinder by more than 20%. On the one hand, material costs can hereby be saved. On the other hand, an obstacle with a small installation space can thus be realized.

For the preparation of drivers for abruptly appearing obstacles using a driving training device with an obstacle, it is advantageous to embody the obstacle according to the invention. The correct behavior in the case of suddenly appearing obstacles can hereby be practiced, wherein even a collision with the obstacle does not result in damage to the vehicle. Particularly preferably, the obstacles are thereby positioned perpendicularly in a base under the roadway and are moved essentially vertically from the resting position to the working position. When the unit of the obstacle is located in the resting position, the obstacle is preferably completely countersunk in the base and, at an upper end, is flush with the roadway so that neither an obstacle nor a recess is recognizable in the roadway.

Where a pneumatically actuated obstacle is used, it has proven effective that the driving training device has several obstacles and a compressed air reservoir, wherein in the compressed air reservoir a quantity of air can be stored with which all obstacles of the driving training device can be actuated simultaneously. A particularly simple embodiment of the driving training device is thus possible. With only few components—in particular the compressed air reservoir, possibly compressors for the provision of the compressed air, valves, preferably solenoid valves, and the obstacles—the driving training device can be ready for operation. If pneumatic actuators are likewise used as reset devices, the compressed air reservoir can also be used for the actuation of the reset device.

Expediently, it is provided that the driving training device has obstacles arranged in one or several rows. Realistic situations can hereby be portrayed in a particularly simple manner.

Particularly preferably, it is provided that a control unit and at least one solenoid valve are provided, with which the at least one obstacle can be actuated, wherein the control unit is effectively connected to at least the one solenoid valve.

The second object is attained in that, in a method of the type named at the outset, the unit with the flexible sleeve is automatically moved to the working position and, if necessary, automatically returned to the resting position during an approach of a training vehicle to the driving training device.

With a method of this type, the correct behavior in the case of rapidly appearing obstacles that appear to be solid can be practiced. By means of the reset device, a collision is avoided even if the driver does not react early enough and does not evade the unit. If the reset device cannot be retracted in time or fails, there is also no risk of damage to the vehicle, since the unit is embodied with a flexible sleeve that, because of its pliability, does not result in more significant damage to the vehicle. Also, only slight or no damage occurs to the sleeve.

Preferably, it is also possible that an approach of a training vehicle is monitored by a control system by means of sensors and that, in the event of a collision that can no longer be avoided by a driver, the obstacles can be moved by the control system to the resting position, e.g., in less than one second. A driving training can thus be conducted fully automatically, and personnel costs can be saved. Preferably, a speed of the training vehicle is thereby also measured in order to estimate a point of collision and in order to be able to move the obstacle early enough, but not too early, to the resting position. Because of the short time within which the object is retracted, realistic situations can be portrayed particularly well.

It is advantageous that, for the simulation of an object crossing a roadway, several obstacles of a driving training device are activated and deactivated by the control system in a staggered manner such that the impression of an object crossing the roadway is created. The correct behavior in the case of people crossing the roadway can thus be suitably practiced. For this purpose, different obstacles that can be actuated pneumatically and are preferably positioned in a row are activated by solenoid valves and, shortly thereafter, moved back to the resting position.

It is advantageous that variably selectable levels of difficulty are provided for a driving training by the control system. For example, both the speed with which the obstacles are moved from the resting position to the working position and also the number of simultaneously appearing obstacles can thereby be varied.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic representation of an obstacle according to the invention;

FIG. 2 shows a further schematic representation of an obstacle according to the invention;

FIG. 3 shows a detail of an object according to the invention in a side view;

FIG. 4 shows a detail of an object according to the invention in a front view;

FIG. 5 shows a driving training device in a side view; and

FIG. 6 shows a further view of a driving training device according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

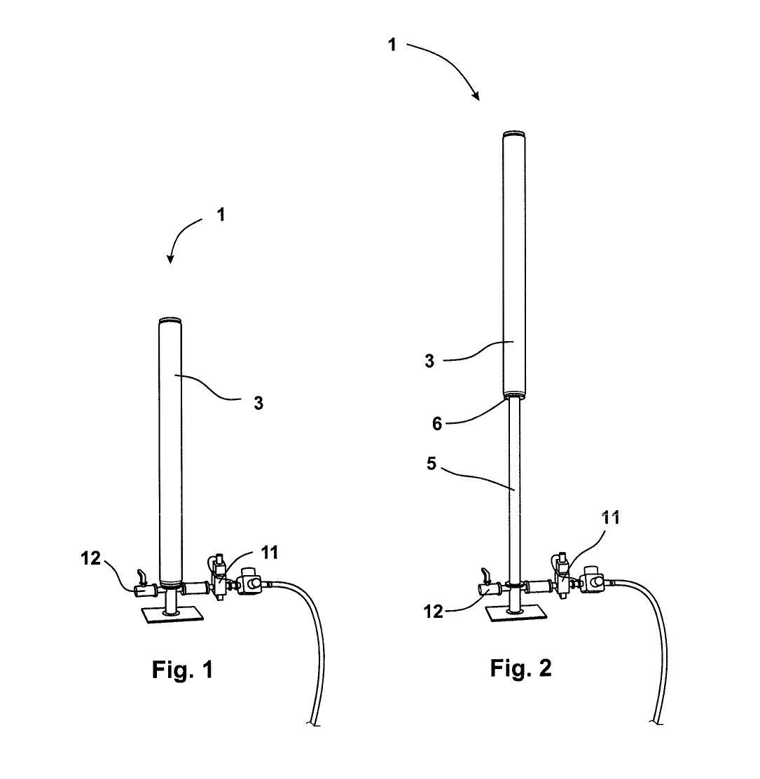

FIG. 1 shows an obstacle 1 according to the invention, wherein the obstacle 1 illustrated in the exemplary embodiment is embodied as a pneumatically activatable obstacle 1. In FIG. 1, a pneumatic hose required for the activation of the obstacle 1 is also illustrated. In FIG. 1, a movable unit with a flexible sleeve 3, e.g., a braided hose, is located in a resting position, wherein the unit bears against a lower stop 7. FIG. 2 shows an obstacle 1 according to the invention, wherein the unit with the sleeve 3 is illustrated in a working position that is located vertically above the resting position. Furthermore, a sliding cylinder 5 can be seen which, together with a sliding part 6, forms a guide on which the unit is moved from the resting position to the working position. In order to move the unit from the resting position to the working position, compressed air is guided from a compressed air reservoir 10 through the pneumatic hose and a feeder valve 11, which is preferably embodied as a solenoid valve, into the hollow sliding cylinder 5, where the compressed air exits the sliding cylinder 5 and enters the unit at an upper end. For an extended obstacle 1, an excess pressure in the unit or in the braided hose is preferably approx. 1 to 2 bar. The unit, which has a braided hose closed at an upper end as a flexible sleeve 3, is thereby moved from the resting position to the working position along the sliding cylinder 5 by a force that acts because of the compressed air present in the braided hose. This movement, which essentially runs in a straight line and vertically, brings the unit to the working position until the unit bears against an upper stop 8. Because the flexible sleeve 3, which is formed as a braided hose, is connected to the sliding part 6, which essentially forms an air tight seal with respect to the sliding cylinder 5, it can be provided that the braided hose is inflated in the working position, whereby an impression of a particularly solid obstacle 1 arises. In the inside of the braided hose, a reset device 4 embodied as a spring is compressed when the unit is moved from the resting position to the working position, such that a reset force acts on the unit and the braided hose in the direction of the resting position. As long as the pressure of the compressed air is present in the braided hose, the spring remains compressed and the unit remains in the working position. Furthermore, a release valve 12 which can preferably be actuated magnetically is provided, with which a pressure inside the sliding cylinder 5 and inside the volume that is formed by the braided hose located in the working position can be relieved. When this valve is opened, the pressure in the braided hose and in the sliding cylinder 5 decreases and the reset force, which acts on the unit via the spring, causes a quick return movement of the unit to the resting position, where the unit once again bears against the lower stop 7.

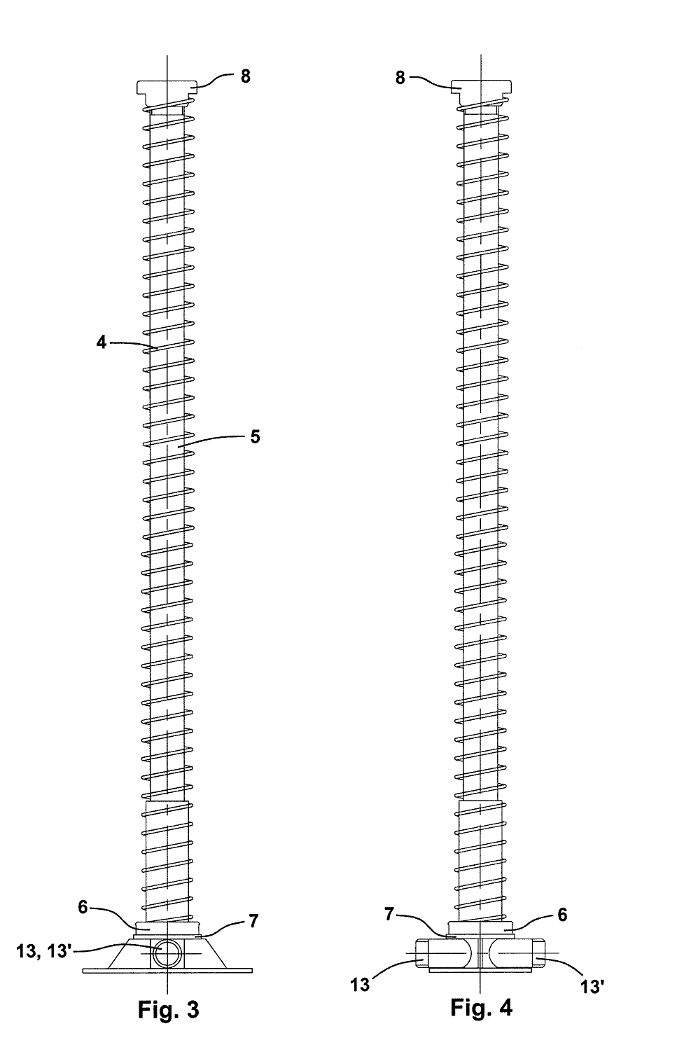

FIG. 3 shows the obstacle 1 from FIG. 1, wherein the braided hose closed at an upper end and connected to the unit is not illustrated. Shown is the sliding cylinder 5 with the reset device 4, which is embodied as a spring, as well as the sliding part 6, which is connected in a sealing manner to the braided hose that in the exemplary embodiment forms the flexible sleeve 3. Preferably, a sealing element 9 is arranged for this purpose between sliding part 6 and sliding cylinder 5. FIG. 4 likewise shows an obstacle 1 according to the invention according to FIG. 3 in a representation rotated 90° from FIG. 3. In FIG. 4, the two openings 13, 13′ in which the compressed air can enter or exit the sliding cylinder 5 are also shown. One opening 13 is connected to the compressed air reservoir 10 via the feeder valve 11, while the second opening 13′ is connected via the release valve 12 to a release space or to the environment, to which the air can escape in order to move the obstacle 1 back to the resting position.

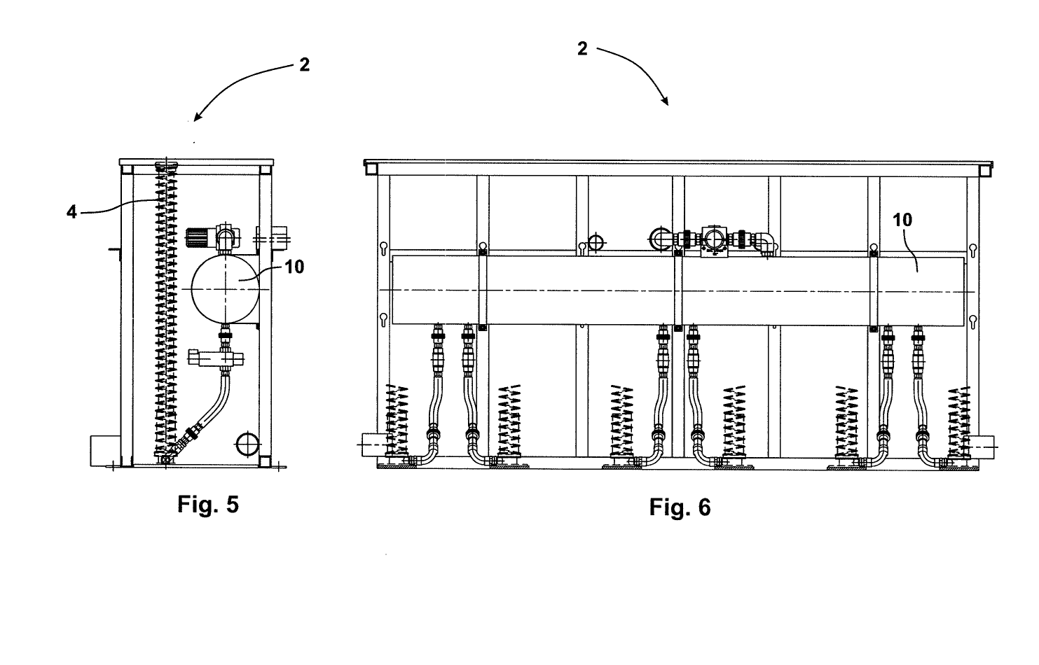

FIG. 5 shows a driving training device 2 arranged beneath a roadway with an obstacle 1 according to the invention, wherein a compressed air reservoir 10 is also schematically represented in which a quantity of air can be stored with which all of the obstacles 1, only indicated by springs, can be moved from the resting position to the working position using the driving training device. FIG. 6 shows the driving training device 2 from FIG. 5 in a side view. In this representation, it can be seen that six obstacles 1 are provided for the driving training device 2, which obstacles are actuated from the compressed air reservoir 10 via solenoid valves. The solenoid valves are actuated by a control system, not illustrated, which among other things has a computer-assisted control as well as sensors with which a distance of the training vehicle to the individual obstacles 1 and a speed of the training vehicle can be measured in order to activate or deactivate the obstacles 1 depending on the distance of the training vehicle and the speed of the same. Activating is thereby to be understood as a movement of the unit with the sleeve 3 from the resting position to the working position and a subsequent retaining in this position, while in the deactivation of an obstacle 1 the unit with the sleeve 3 is moved from the working position to the resting position.

During operation, a driver who is participating in a driving technique training is instructed to drive a training vehicle in the direction of the obstacles 1. The distance of the training vehicle from the obstacles 1 is thereby measured by the sensor technology. This can for example be carried out using inductive, optical or capacitive sensors. As soon as the training vehicle falls below a predefined distance to the driving training device 2, at least one obstacle 1 is activated in that the feeder valve 11 between the compressed air reservoir 10 and the obstacle 1 is opened, so that compressed air bears against the obstacle 1 and so that the unit of the obstacle 1 with the braided hose, which forms the sleeve 3, is moved from the resting position to the working position. Depending on the freely selectable mode of operation, several or only one single object 1 can thereby be moved from the resting position to the working position. Alternatively, it is also possible to sequentially activate or deactivate individual obstacles 1 in order to portray animated obstacles 1. If the driver does not react early enough and the distance between the training vehicle and the obstacle 1 decreases below a predefined value, a second solenoid valve on the obstacle 1 is opened so that the compressed air can escape from the obstacle 1 and so that the unit of the reset device 4 is quickly moved back to the resting position from the working position. This can be carried out in less than one second so that a collision of the training vehicle with the obstacle 1 can be avoided. The distance at which the obstacle 1 is again moved into the resting position can thereby also be dependent on the speed of the training vehicle, so that at high speeds the obstacle 1 is already moved into the resting position again starting with a falling-below of a greater distance. Simultaneously, the solenoid valve that connects the compressed air reservoir 10 to the obstacle 1 is closed so that the compressed air of the compressed air reservoir 10 does not escape into the environment. With a programming of the control system, various different speeds of the extendable and retractable obstacles 1 can thereby be realized, whereby a degree of difficulty of the driving training can be changed as desired. With the flexible sleeve 3 of the obstacle 1, damage to the vehicle is avoided even if an error occurs and the obstacle 1 cannot be deactivated before a collision.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. An obstacle for a driving training device comprising a unit that can be moved, essentially in a straight line, between a resting position and a working position, wherein the unit comprises a flexible sleeve and a reset device for returning the sleeve to the resting position.

2. The obstacle according to claim 1, wherein the unit can be actuated pneumatically.

3. The obstacle according to claim 1, wherein a guide is provided which comprises a sliding cylinder and a sliding part.

4. The obstacle according to claim 3, wherein the guide is embodied with stops for the unit at a head end and at a base end.

5. The obstacle according to claim 3, wherein the sleeve is movably arranged on the sliding cylinder via the sliding part.

6. The obstacle according to claim 3, wherein the reset device is connected to the sliding cylinder and the unit.

7. The obstacle according to claim 1, wherein the reset device is embodied as a spring.

8. The obstacle according to claim 1, wherein the reset device is embodied as a pneumatic actuator, in particular as a pneumatic cylinder.

9. The obstacle according to claim 1, wherein the sleeve is composed of a braiding, in particular a braided hose.

10. The obstacle according to claim 3, wherein at least one sealing element attached to the sliding cylinder or the sliding part is provided.

11. The obstacle according to claim 3, wherein the sliding cylinder is arranged in a stationary manner and embodied hollowly, wherein the unit with the sleeve is arranged movably in a direction on the sliding cylinder so that compressed air can be fed into the sleeve through the hollow sliding cylinder.

12. The obstacle according to claim 2, wherein a length of the sleeve does not exceed a length of the sliding cylinder by more than 20%.

13. A driving training device with an obstacle, wherein the obstacle is embodied according to claim 1.

14. The driving training device according to claim 13, wherein the unit can be actuated pneumatically, wherein the driving training device has several obstacles and a compressed air reservoir, wherein in the compressed air reservoir a quantity of air can be stored with which all obstacles of the driving training device can be actuated simultaneously.

15. The driving training device according to claim 13, wherein the driving training device has obstacles arranged in one or several rows.

16. The driving training device according to claim 13, wherein a control unit and at least one solenoid valve are provided, with which the at least the one obstacle can be actuated, wherein the control unit is effectively connected to the at least the one solenoid valve.

17. A method for extending a spontaneously appearing and solid-looking object on a roadway using a driving training device which comprises at least one obstacle with a unit that has a flexible sleeve and that is moved, essentially in a straight line, between a resting position and a working position, wherein the unit with the flexible sleeve is automatically moved to the working position and, if necessary, automatically returned to the resting position during an approach of a training vehicle to the driving training device.

18. The method according to claim 17, wherein an approach of a training vehicle is monitored by a control system by means of sensors and in that, in the event of a collision that can no longer be avoided by a driver, the obstacles are moved to the resting position by the control system.

19. The method according to claim 17, wherein for the simulation of an object crossing a roadway, several obstacles of a driving training device are activated and deactivated by the control system in a staggered manner such that the impression of an object crossing the roadway is created.

20. The method according to claim 17, wherein variably selectable levels of difficulty are provided for a driving training by the control system.
